(19) United States
(12) Patent Application Publication
(10) Pub. No.: US 2012/0214066 A1
(43) Pub. Date: Aug. 23, 2012

(54) High Aspect Ratio Patterning of Silicon

(75) Inventors: Michael N. Miller, Austin, TX (US); Fen Wan, Austin, TX (US); Vikramjit Singh, Austin, TX (US); Darren D. Donaldson, Austin, TX (US); Gerard M. Schmid, Rensselaer, NY (US); Sidlgata V. Sreenivasan, Austin, TX (US); Frank Y. Xu, Round Rock, TX (US)

(73) Assignees: BOARD OF REGENTS, THE UNIVERSITY OF TEXAS SYSTEM, Austin, TX (US); MOLECULAR IMPRINTS, INC., Austin, TX (US)

(21) Appl. No.: 13/398,442

(22) Filed: Feb. 16, 2012

Related U.S. Application Data
(60) Provisional application No. 61/443,962, filed on Feb. 17, 2011.

(51) Int. Cl. H01M 4/38; H01M 4/04; B82Y 30/00

(52) U.S. Cl. 429/219; 429/218.1; 216/13; 977/762

(57) ABSTRACT

A silicon nanowire array including a multiplicity of silicon nanowires extending from a silicon substrate. Cross-sectional shape of the silicon nanowires and spacing between the silicon nanowires can be selected to maximize the ratio of the surface area of the silicon nanowires to the volume of the nanowire array. Methods of forming the silicon nanowire array include a nanoimprint lithography process to form a template for the silicon nanowire array and an electroless etching process to etch the template formed by the nanoimprint lithography process.

### CROSS REFERENCE TO RELATED APPLICATIONS

The present application claims priority to U.S. provisional application No. 61/443,962 filed Feb. 17, 2011, which is hereby incorporated by reference.

### TECHNICAL FIELD

The present invention is related to high aspect ratio patterning of silicon substrates using methods including nanoimprint lithography.

### BACKGROUND

Electroless etching has been used to form silicon nanostructures from a silicon substrate. For example, Qui et al., “Self-selective electroless plating: An approach for fabrication of functional 1D nanomaterials,” Materials Science and Engineering R 61 (2008) 59-77, which is incorporated by reference herein, describes methods used to form silicon nanowires and nanowire arrays on silicon substrates using metal-assisted electroless etching. These methods can sometimes have limitations regarding, for example, cross-sectional shape and surface-to-volume ratio of the nanowires, and can involve high-temperature, low-pressure processing steps, such as reactive ion etching.

### SUMMARY

In one aspect, forming a nanopatterned silicon nanowire array includes forming a metal-containing layer on a silicon substrate, disposing a polymerizable composition on the metal-containing layer, and contacting the polymerizable composition with a patterned imprint lithography template. The metal-containing layer includes a noble metal. The polymerizable composition is solidified to form a patterned layer, having protrusions and recessions, on the substrate. The imprint lithography template is separated from the patterned layer, and portions of the patterned layer in the recessions are removed to expose portions of the metal-containing layer. At least some of the metal ions are reduced, such that the reduced metal is in contact with the silicon substrate. The exposed portions of the metal-containing layer are contacted with an etching solution for a length of time to etch the silicon substrate in contact with the reduced metal, thereby forming a nanowire array including a multiplicity of silicon nanowires extending from the silicon substrate.

In another aspect, forming a nanopatterned silicon nanowire array includes disposing a metal-containing polymerizable composition on a silicon substrate, and contacting the metal-containing polymerizable composition with a patterned imprint lithography template. The metal-containing polymerizable composition includes a noble metal. The polymerizable composition is solidified to form a patterned metal-containing layer, having protrusions and recessions, on the substrate. The imprint lithography template is separated from the patterned layer, and portions of the patterned layer are removed to expose portions of the silicon substrate, leaving metal in contact with the silicon substrate. Some of the metal is reduced. The reduced metal is contacted with an etching solution for a length of time to etch the silicon substrate, thereby forming a nanowire array including a multiplicity of silicon nanowires extending from the silicon substrate.

In another aspect, forming a nanopatterned silicon nanowire array includes disposing a polymerizable composition on a silicon substrate, and contacting the polymerizable composition with a patterned imprint lithography template. The polymerizable composition is solidified to form a patterned layer, having protrusions and recessions, on the substrate. The imprint lithography template is separated from the patterned layer, and portions of the patterned layer are removed to expose portions silicon substrate. The polymerizable composition is substantially free of metal. The exposed portions of the silicon substrate are contacted with a metal-ion-containing solution to etch the silicon substrate, thereby forming a nanowire array including a multiplicity of silicon nanowires extending from the silicon substrate.

In another aspect, forming a nanopatterned silicon nanowire array includes disposing a polymerizable composition on a silicon substrate, and contacting the polymerizable composition with a patterned imprint lithography template. The polymerizable composition is solidified to form a patterned layer, having protrusions and recessions, on the substrate. The imprint lithography template is separated from the patterned layer, and portions of the patterned layer are removed to expose portions of the silicon substrate. Metal is applied to the exposed portions of the silicon substrate. The metal may be in the form of noble metal ions. The metal ions can be reduced and contacted with an etching solution to etch the silicon substrate, thereby forming a nanowire array comprising a multiplicity of silicon nanowires extending from the silicon substrate.

In another aspect, a lithium ion battery includes a cathode, an anode including a nanopatterned silicon nanowire array having silicon nanowires extending from a silicon substrate, the silicon nanowires having a critical dimension and a pitch corresponding to a patterned surface of a nanoimprint lithography template used to form a patterned layer on the silicon substrate, and an electrolyte. The anode and cathode are electrically connected and in contact with the electrolyte.

In certain implementations, one or more of the above aspects includes one or more of the following features. The silicon nanowires can extend vertically from the silicon substrate from which they are formed. The metal can include a noble metal, ions of a noble metal, or any combination thereof. A metal-containing layer can be formed by sputter coating or vacuum depositing a noble metal on the silicon substrate. In some cases, a metal-containing layer is formed in an evaporation process. A metal-containing layer can be formed by polymerizing a polymerizable composition comprising a noble metal on the silicon substrate. The noble metal can be silver, and ions of the noble metal can be silver ions.

The nanoimprint lithography template can be a pillar tone template or a hole tone template. A patterned layer, or portions of a patterned layer (e.g., portions of a patterned layer between protrusions) can be removed to expose, for example, the silicon substrate, and can leave a metal-rich region on a surface of the silicon substrate. The metal-rich region can include a noble metal, noble metal ions, or a combination thereof. In some cases, removing portions of the patterned layer in the recessions to expose portions of the first polymeric layer includes a descum process. In certain cases, removing portions of the patterned layer in the recessions to expose portions of the layer includes exposing the portions of the patterned layer in the recessions to vacuum ultraviolet radiation.

In some embodiments, an etching solution includes hydrofluoric acid. In some cases, an etching solution includes noble metal ions, such as silver ions, and hydrofluoric acid. Contacting the exposed portions of a metal-containing layer with an etching solution can include immersing the silicon substrate in the etching solution.

The cross-sectional shape and density of the nanowires formed as described herein can be determined at least in part by the patterned nanoimprint lithography template. In some cases, the surface area to volume ratio of the nanowires is selected by the patterned nanoimprint lithography template and the length of time the etching solution is in contact with the exposed portion of the first polymeric layer. The patterned nanoimprint lithography template can be selected to maximize the surface area of silicon in the nanowire array with respect to a length of the nanowires or with respect to a density of the nanowires.

A critical dimension of the nanowires can be determined by the patterned nanoimprint lithography template. A critical dimension of the nanowires can be between about 10 nm and about 500 nm; a pitch of the nanowires can be between about 100 nm and about 1 μm; and/or a length of the nanowires can be between about 5 nm and about 20 μm. The aspect ratio of the nanowires can be at least about 10:1 or at least about 20:1. A cross-sectional shape of the nanowires is circular, elliptical, triangular, rectangular, hexagonal, lobed, or in the shape of a square or parallelogram. The nanowires can be in a close packed configuration. In some cases, portions of protrusions from a patterned layer are adhered to distal ends of the nanowires, and can be removed from the distal ends of the nanowires.

In some cases, one or more additional layers can be formed on a silicon substrate before disposing a polymerizable composition or a metal layer on the silicon substrate. One of the one or more additional layers can be, for example, an adhesion layer.

Nanopatterned silicon nanowire arrays can be formed by any combination of aspects and/or features described herein. The nanopatterned silicon nanowire arrays can be used, for example, as an electrode in a lithium ion battery. A thermoelectric cooler can include a nanopatterned silicon nanowire array formed by any method described herein.

Thus, particular embodiments have been described. Variations, modifications, and enhancements of the described embodiments and other embodiments can be made based on what is described and illustrated. In addition, one or more features of one or more embodiments may be combined. The details of one or more implementations and various features and aspects are set forth in the accompanying drawings, the description, and the claims below.

### BRIEF DESCRIPTION OF THE DRAWINGS

FIG. 1 illustrates a simplified side view of a lithographic system.

FIG. 2 illustrates a simplified side view of the substrate illustrated in FIG. 1, having a patterned layer thereon.

FIG. 3 is a flowchart showing steps in a process for forming a nanopatterned silicon nanowire array.

FIG. 4 illustrates a block diagram of an exemplary system for removing solidified polymerizable material.

FIG. 5 illustrates a flow chart of an exemplary method for removing solidified polymerizable material.

FIG. 6 illustrates an atomic force microscopy (AFM) profile of 40 nm half-pitch resist features prior to radiation exposure.

FIG. 7 illustrates a graphical representation of rate of removal of a residual layer by exposure to vacuum ultraviolet (VUV) radiation in air.

FIG. 8 illustrates an AFM profile of 40 nm half-pitch resist features after 30 seconds of radiation exposure (VUV) in air.

FIG. 9 illustrates an AFM profile of 40 nm half-pitch resist features after 60 seconds of radiation exposure (VUV) in air.

FIG. 10 illustrates a graphical representation of rate of removal of a residual layer by radiation exposure (VUV) in a nitrogen-enriched environment.

FIG. 11 illustrates an AFM profile of 40 nm half-pitch resist features after 30 seconds of radiation exposure (VUV) in a nitrogen-enriched environment.

FIG. 12 illustrates an AFM profile of 40 nm half-pitch resist features after 60 seconds of radiation exposure (VUV) in a nitrogen-enriched environment.

FIGS. 13A-13H illustrate steps in a process to form a nanopatterned silicon nanowire array.

FIGS. 14A and 14B are scanning electron micrograph (SEM) images of a silicon nanowire array formed using nanoimprint lithography and electroless etching.

FIG. 15 is a flowchart showing steps in a process to form a nanopatterned silicon nanowire array.

FIGS. 16A-16H illustrate steps in a process to form a nanopatterned silicon nanowire array.

FIGS. 17A-17G illustrate steps in a process to form a nanopatterned silicon nanowire array.

FIG. 18 is a flowchart showing steps in a process to form a nanopatterned silicon nanowire array.

FIGS. 19A-19H illustrate steps in a process to form a nanopatterned silicon nanowire array.

FIGS. 20A-20D are SEM images of a silicon nanowire array formed using nanoimprint lithography and electroless etching.

FIG. 21 is an SEM image of a silicon nanowire array formed with a pillar tone imprint.

FIG. 22 is a flowchart showing steps in a process to form a nanopatterned silicon nanowire array.

FIGS. 23A-23H illustrate steps in a process to form a nanopatterned silicon nanowire array.

FIG. 24 depicts a lithium ion battery with an anode including a nanopatterned silicon nanowire array.

### DETAILED DESCRIPTION

As described herein, silicon nanowire arrays are formed from a silicon substrate using nanoimprint lithography and electroless etching. The nanowires in the array are formed with a high aspect ratio, having selected cross-sectional shape, surface area, pitch, volume, and critical dimension control. The arrays are suitable for use in thermoelectric coolers, lithium ion battery electrodes, and other applications including applications in which a high surface area to volume ratio of silicon can be advantageous.

Exemplary imprint lithography processes are described in detail in numerous publications, such as U.S. Patent Publication No. 2004/0065976, U.S. Patent Publication No. 2004/0065252, and U.S. Pat. No. 6,936,194, all of which are incorporated by reference herein.

An imprint lithography technique disclosed in each of the aforementioned U.S. patent publications and patent includes formation of a relief pattern in a formable (e.g., polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

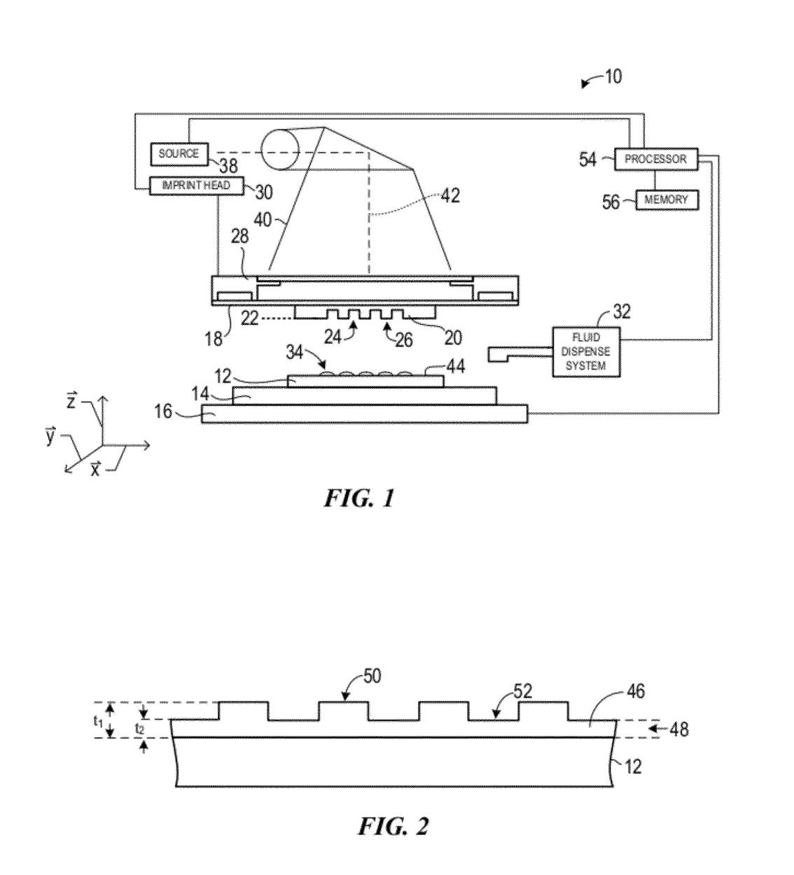

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electrostatic, electromagnetic, and/or the like. Exemplary chucks are described in U.S. Pat. No. 6,873,087, which is incorporated by reference herein.

Substrate 12 and substrate chuck 14 may be further supported by stage 16. Stage 16 may provide translational and/or rotational motion along the x, y, and z-axes. Stage 16, substrate 12, and substrate chuck 14 may also be positioned on a base (not shown).

Spaced-apart from substrate 12 is template 18. Template 18 may include a body having a first side and a second side with one side having a mesa 20 extending therefrom towards substrate 12. Mesa 20 having a patterning surface 22 thereon. Further, mesa 20 may be referred to as mold 20. Alternatively, template 18 may be formed without mesa 20.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 includes features defined by a plurality of spaced-apart recesses 24 and/or protrusions 26, though embodiments are not limited to such configurations (e.g., patterning surface 22 may be a planar surface). Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electrostatic, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further include a fluid dispense system 32. Fluid dispense system 32 may be used to deposit formable material 34 (e.g., polymerizable material) on substrate 12. Formable material 34 may be positioned upon substrate 12 using techniques, such as drop dispense, spin-coating, dip coating, chemical vapor deposition (CVD), physical vapor deposition (PVD), thin film deposition, thick film deposition, and/or the like. Formable material 34 may be disposed upon substrate 12 before and/or after a desired volume is defined between mold 22 and substrate 12 depending on design considerations. Formable material 34 may include a monomer mixture as described in U.S. Pat. No. 7,157,036 and U.S. Patent Publication No. 2005/0187339, both of which are incorporated by reference herein. In some examples, formable material 34 includes functional material having use within the bio-domain, solar cell industry, battery industry, and/or other industries requiring functional materials. For example, formable material 34 may include biocompatible materials (e.g., polyethylene glycol (PEG)), solar cell materials (e.g., n-type materials, p-type materials), and the like.

Referring to FIGS. 1 and 2, system 10 may further include energy source 38 coupled to direct energy 40 along path 42. Imprint head 30 and stage 16 may be configured to position template 18 and substrate 12 in superimposition with path 42. System 10 may be regulated by processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by formable material 34. For example, imprint head 30 may apply a force to template 18 such that mold 20 contacts formable material 34. After the desired volume is filled with formable material 34, source 38 produces energy 40, e.g., ultraviolet radiation, causing formable material 34 to solidify and/or cross-link, conforming to a shape of surface 44 of substrate 12 and patterning surface 22, defining patterned layer 46 on substrate 12. Patterned layer 46 may include a residual layer 48 and a plurality of features shown as protrusions 50 and recessions 52, with protrusions 50 having a thickness t₁ and residual layer having a thickness t₂.

The above-mentioned system and process may be further employed in imprint lithography processes and systems referred to in U.S. Pat. No. 6,932,934, U.S. Pat. No. 7,077,992, U.S. Pat. No. 7,179,396, and U.S. Pat. No. 7,396,475, all of which are incorporated by reference herein.

Various processes may be used to form a silicon nanowire array using nanoimprint lithography and electroless etching. In one embodiment, a metal-containing layer is formed on a silicon substrate, a patterned layer is formed on the metal-containing layer with a nanoimprint lithography process, and electroless etching is used to form a silicon nanowire array. In another embodiment, a metal-containing patterned layer is formed on a silicon substrate with a nanoimprint lithography process as described with respect to FIGS. 1 and 2, and electroless etching is used to form a silicon nanowire array. In another embodiment, a patterned layer is formed on a silicon substrate with a nanoimprint lithography process, and an etching solution including noble metal ions is used to form a silicon nanowire array. The patterned layer in these embodiments can be a pillar tone imprint or a hole tone imprint. Nanowires formed in these processes have a density and cross-sectional shape determined at least in part by the pattern on the nanoimprint lithography template. Thus, a nanoimprint lithography template can be designed to achieve a desired surface to volume ratio for silicon in the nanowire array.

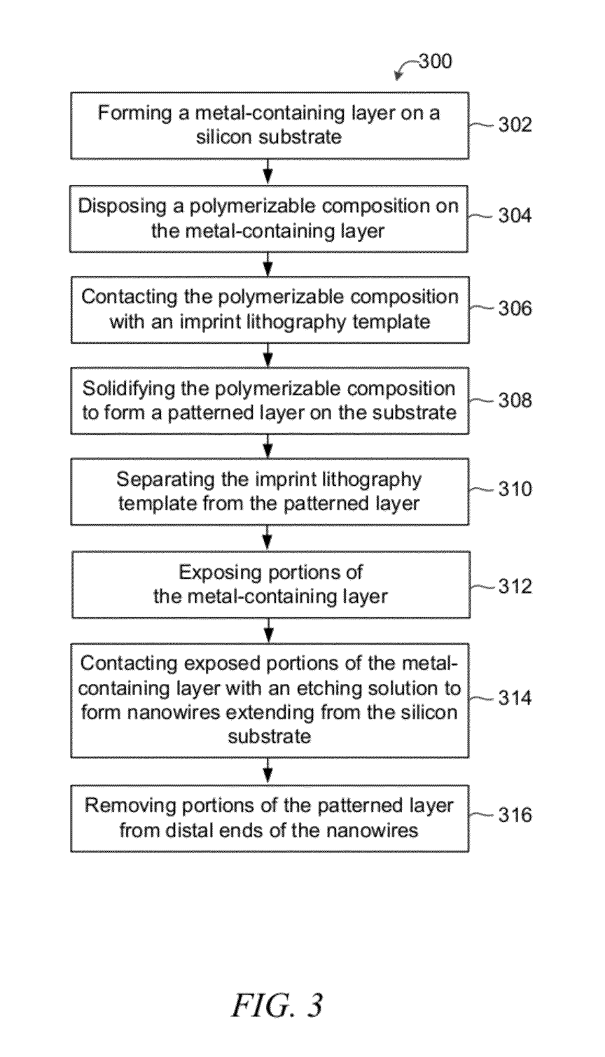

FIG. 3 is a flowchart showing process 300 for forming a silicon nanowire array from a silicon substrate. In 302, a metal-containing layer is formed on the silicon substrate. The metal is a noble metal such as, for example, silver, gold, or palladium. As used herein, unless otherwise noted, “metal” generally refers to metal in any oxidation state or any combination of oxidation states. For example, at least some of the metal can be in ionic form. In some cases, the metal-containing layer is formed directly on the surface of the silicon substrate. In other cases, one or more additional layers (e.g., non-metal-containing layers) are formed on the silicon substrate prior to formation of the metal-containing layer. In one example, an adhesion layer substantially free from metal is formed directly on the surface of a silicon substrate, and a metal-containing layer is formed on the adhesion layer.

In some embodiments, the metal-containing layer is formed by sputter coating or vacuum depositing a layer containing one or more noble metals (e.g., gold and palladium) on a silicon substrate by processes known in the art. In other embodiments, a polymerizable composition including a noble metal is disposed on the substrate and then solidified. In some cases, the noble metal is added to the polymerizable composition in the form of a noble metal salt (e.g., silver acetate, silver lactate, or the like), metal nanoparticles, etc. In some examples, a metal-containing polymerizable composition is an adhesion layer formed on the silicon substrate. Examples of polymerizable compositions suitable for use as adhesion layers include TRANSPIN and VALMAT, available from Molecular Imprints, Inc. (Austin, Tex.). In some examples, a metal-containing polymerizable composition is an imprint resist used to form a patterned layer directly on a silicon substrate or on a metal-containing or non-metal-containing intermediate layer, such as an adhesion layer.

In 304, a polymerizable composition (e.g., formable material 34) is disposed on the metal-containing layer as described herein with respect to FIGS. 1 and 2. Examples of formable material 34 include MONOMAT, available from Molecular Imprints, Inc. In 306, the polymerizable material is contacted with a patterned imprint lithography template. In 308, the polymerizable material is solidified to form a patterned layer with protrusions and recessions, and in 310 the imprint lithography template is separated from the patterned layer, leaving the patterned layer adhered to the metal-containing layer.

In 312, portions of the patterned layer between the protrusions are removed to expose portions of the metal-containing layer. The portions of the patterned layer between the protrusions can be removed, for example, by a descum process designed to remove a residual layer in an imprint lithography process. One method for removing a residual layer from a patterned layer includes a plasma-based etching process (e.g., oxygen plasma). Such processes are capable of directional (i.e., primarily vertical) etching of solidified polymerizable material, such that the residual layer is removed with minimal alterations to the lateral dimensions of the protrusions. Plasma-based etching processes, however, may not be suitable for all applications due to factors including high cost, low throughput, and the need for a reduced pressure environment. Alternative techniques for removing solidified polymerizable material provide higher throughput and reduced cost and may not require a reduced pressure processing environment. Additionally, removal techniques described herein may be applicable for removing underlying organic layers formed by non-imprint methods.

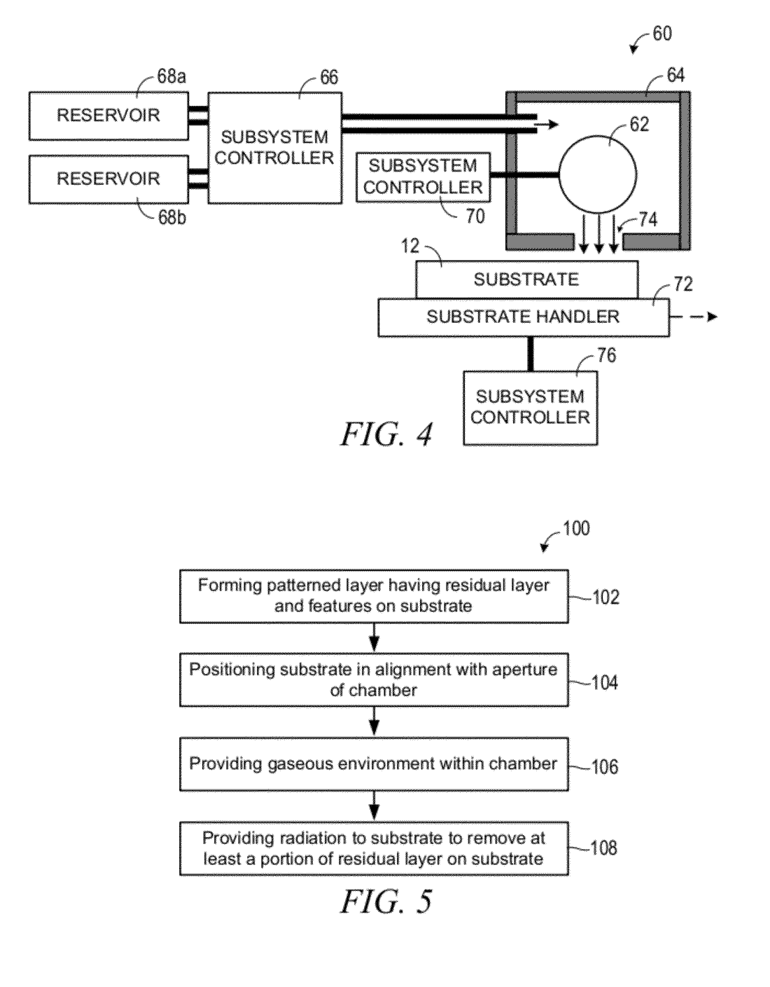

FIG. 4 illustrates an exemplary system 60 for removal of solidified polymerizable material 34. System 60 includes a radiation source 62. Radiation source 62 is capable emitting radiation in the vacuum ultraviolet (VUV) region of the electromagnetic spectrum. In an example, radiation source 62 emits radiation in a wavelength range between about 140 nm and about 190 nm. In one embodiment, radiation is provided by a xenon excimer dielectric barrier discharge lamp (e.g., with a peak intensity at a wavelength of approximately 172 nm and a spectral bandwidth of approximately 15 nm FWHM). Intensity of radiation at the surface of residual layer 48 is approximately 5 to 150 mW/cm².

Radiation source 62 is enclosed within a chamber 64. A gas may be present inside chamber 64. In an example, the gas includes at least 95 percent nitrogen and less than 5 percent oxygen. The composition of gas is controlled by a first subsystem 66. First subsystem 66 provides gas from at least one reservoir 68. For example, in FIG. 4, subsystem 66 provides gas from reservoir 68a and/or 68b. Radiation output of radiation source 62 is controlled by second subsystem 70. A removal rate of residual layer 48 can be adjusted by modification of the intensity of radiation source 62 by second subsystem 70.

System 60 includes a substrate handler 72 to provide scanning of substrate 12 by an exposure aperture 74 of chamber 64. Movement of substrate handler 72 may be controlled by a third subsystem controller 76. For example, removal rate of solidified polymerizable material 34 on substrate 12 may be adjusted by third subsystem controller 76 modifying linear speed of substrate handler 72.

In one embodiment, substrate handler 72 includes a substrate chuck and a linear actuator. The substrate chuck and linear actuator are constructed to scan the substrate beneath exposure aperture 74 of chamber 64. In another embodiment, substrate handler 72 includes a plurality of rotating rollers capable of actuating substrate 12 beneath exposure aperture 74 of chamber 64.

It should be noted that first subsystem 66, second subsystem 70 and/or third subsystem 76 may be integral to each other. Alternatively, first subsystem 66, second subsystem 70, and/or third subsystem 76 may be separate systems.

FIG. 5 illustrates an exemplary method 100 for removal of residual layer 48 from patterned layer 46 on substrate 12. In 102, patterned layer 46 having residual layer 48 and features 50 and 52 is formed on substrate 12 using the system and methods described in relation to FIGS. 1 and 2. In 104, subsystem controller 76 positions substrate 12 in alignment with aperture 74 of chamber 64. In 106, subsystem controller 66 provides a gaseous environment within chamber 64. In 108, subsystem 70 provides radiation (e.g., VUV radiation) to substrate 12 through aperture 74 of chamber 64. For example, subsystem 70 can control radiation source 62 to provide vacuum ultraviolet radiation with a peak intensity of approximately 172 nm and a spectral bandwidth of approximately 15 nm FWHM.

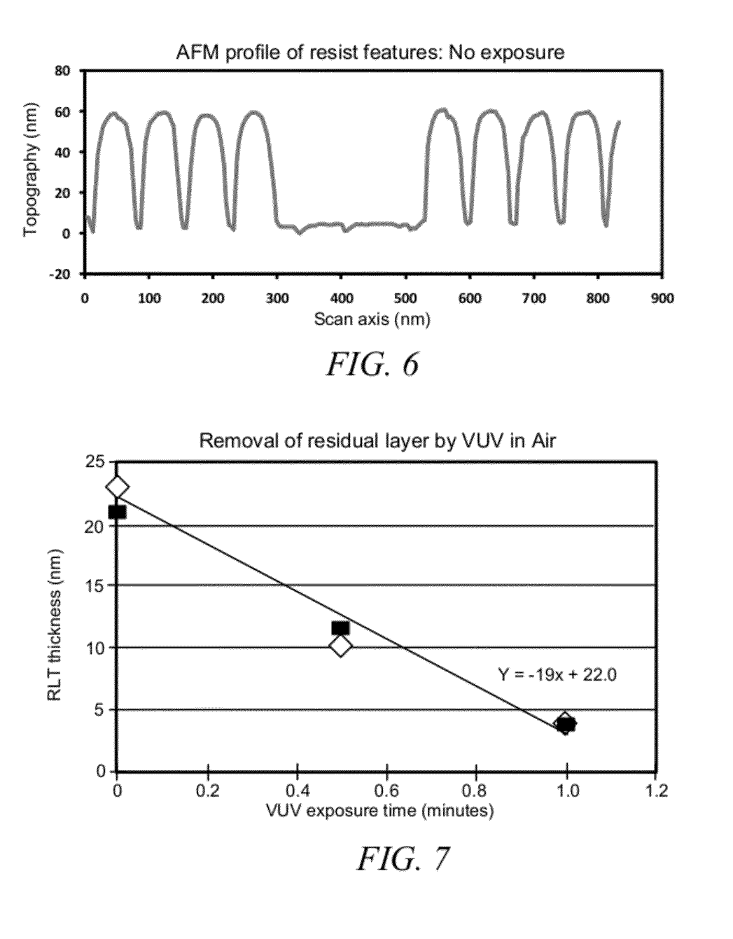

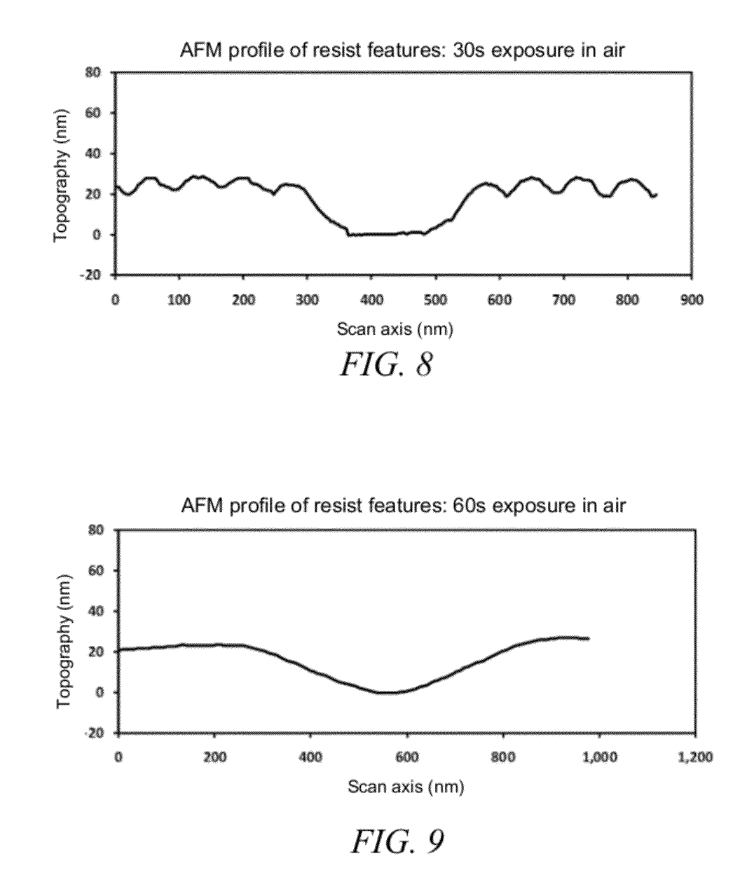

The type of gaseous environment within chamber 64 can affect the quality of features 50 and 52 remaining after removal of residual layer 48. For example, FIG. 6 illustrates a profile of exemplary resist features 50 and 52 measured by atomic force microscopy prior to exposure to radiation. Upon radiation exposure (e.g., VUV radiation) of patterned layer 46 in an air environment (approximately 79% nitrogen and 21% oxygen), residual layer 48 may be removed at a rate of approximately 19 nm/min as shown in FIG. 7. Features 50 and 52 of patterned layer 46, however, may be severely degraded such that the pattern is almost completely degraded after 60 seconds of exposure in air as shown in FIGS. 8 and 9 (illustrating exposure at 30 seconds in air and 60 seconds in air, respectively).

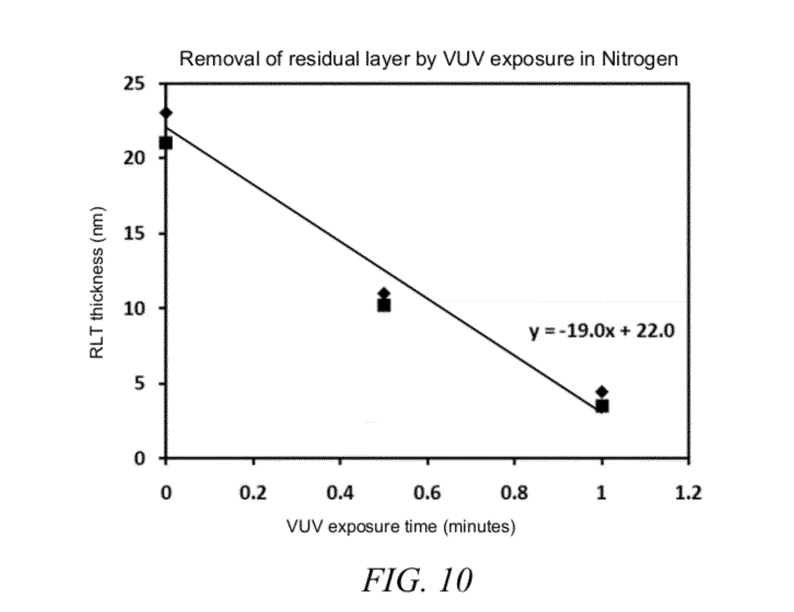

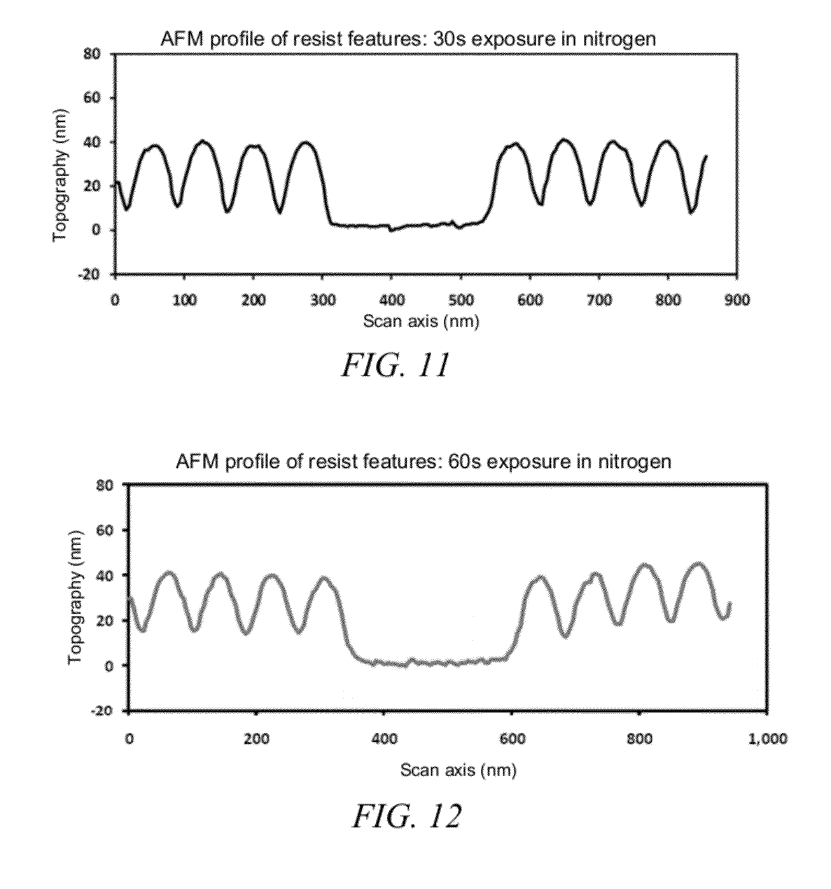

In providing the exposure process in a nitrogen-enriched environment, the rate of removal of residual layer 48 may be substantially similar to results seen in an air environment. However, the quality of features 50 and 52 may be substantially retained during the process. For example, increasing the amount of nitrogen to provide approximately 98% nitrogen and less than 2% oxygen may substantially increase the quality of the pattern, enabling removal of residual layer 48 at a rate of approximately 19 mm/min, as shown in FIG. 10, while substantially preserving desired structures. In particular, as shown in FIGS. 11 and 12, pattern quality may be substantially retained even after 30 seconds or 60 seconds of exposure, respectively, within the nitrogen-enriched environment.

After or during removal of the residual layer to expose portions of the metal-containing layer in 312, metal ions in the metal-containing layer may be reduced. In 314, exposed portions of the metal-containing layer are contacted with an etching solution for a length of time to etch the silicon substrate where reduced metal (metal with an oxidation state of zero) is in contact with the silicon substrate. In some cases, the reduced metal may include metal ions that have been reduced, for example, in an etching process. In other cases, the metal-containing layer, as deposited, may include metal with an oxidation state of zero (e.g., when the metal-containing layer includes metal nanoparticles). Contacting the exposed portions of the metal-containing layer can include immersing the silicon substrate in an etching solution. The etching processes described to form silicon nanowires herein rely on wet etching and can be performed in the absence of reactive ion etching.

The etching solution is an aqueous solution including an acid or a base (e.g., a strong acid or a strong base). In some cases, the etching solution is an aqueous solution including a strong acid and metal ions. In one example, the metal in the metal-containing layer includes gold and palladium, and the etching solution includes hydrofluoric acid (e.g., 5M HF). In another example, the silicon substrate has a <110> plane, and potassium hydroxide is used as the etching solution. When the metal-containing layer includes silver, a suitable etching solution includes hydrofluoric acid (e.g., 5M HF). During the etching process with hydrofluoric acid etching solution, the hydrofluoric acid reacts with the silicon dioxide to form silicon hexafluoride, etching away silicon in places where reduced metal is in contact with the silicon.

Etching may occur substantially vertically though the substrate. For example, when an etching solution including silver nitrate and hydrofluoric acid is used, silicon, including crystalline forms of silicon and amorphous and nano/micro crystalline forms of silicon (e.g., silicon films deposited by vacuum techniques including chemical vapor deposition and sputtering) are etched substantially vertically. This can be in contrast with wet etching processes using, for example, potassium hydroxide, in which the resulting structure depends on the crystalline orientation of the silicon. Vertical etching through the regions of the silicon substrate that surround the protrusions yields pillars (i.e., nanowires) that extend from the silicon substrate.

Etching depth (or nanowire length) can increase with increased etching time. After etching is complete, portions of the patterned layer (e.g., protrusions 50) adhered to distal ends of the nanowires are removed in 316. Removing this polymeric material may include dissolving the material with a solvent or a solution. For example, acetone can be used to dissolve a poly(methyl methacrylate) (PMMA) layer, and a Piranha solution including sulfuric acid and hydrogen peroxide can be used to dissolve other polymeric imprint resists, such as MONOMAT. In some cases, reduced metal (e.g., as deposited or formed during the etching process) is removed from the silicon substrate, for example, with nitric acid or a stripper including potassium iodide, iodine, and water.

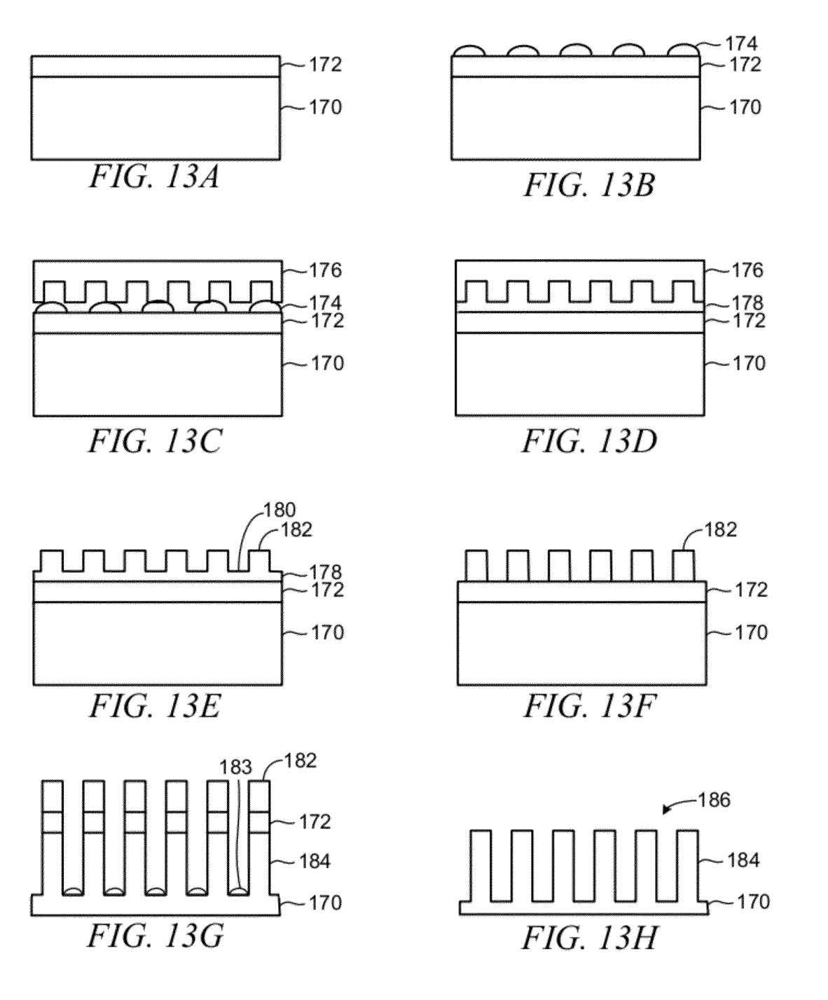

FIGS. 13A-13H illustrate the process described in FIG. 3. In FIG. 13A, metal-containing layer 172 is shown on silicon substrate 170. In FIG. 13B, polymerizable material 174 is shown on metal-containing layer 172. In FIG. 13C, nanoimprint lithography template 176 is shown in contact with polymerizable material 174. Polymerizable material 174 is solidified to form patterned layer 178, as shown in FIG. 13D. Nanoimprint lithography template 176 is separated from patterned layer 178, as shown in FIG. 13E. Residual portions 180 are shown between protrusions 182. FIG. 13F shows resist protrusions 182 remaining after residual portions 180 have been etched away. FIG. 13G shows metal-rich regions 183, where reduced metal is in contact with silicon substrate 170, between silicon nanowires 184 after an electroless etching process. Protrusions 182 from patterned layer 178 are adhered to the distal ends of nanowires 184. In some cases, as shown for silicon nanowire array 186 in FIG. 13H, metal from metal-containing layer 172 and protrusions 182 are removed from nanowires 184.

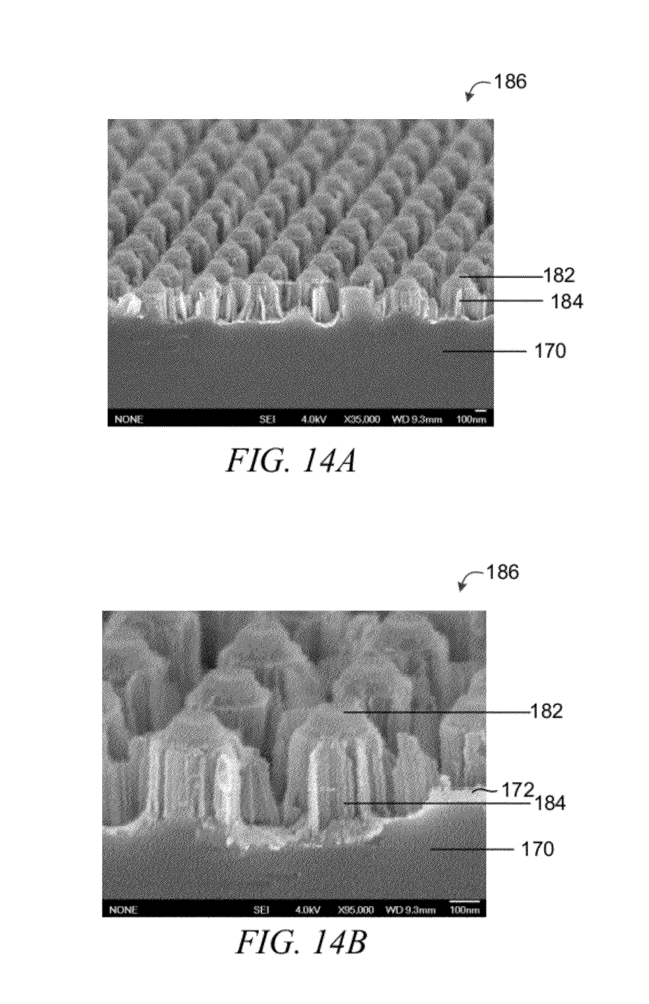

FIGS. 14A and 14B show images of array 186 of silicon nanowires 184 formed by sputter coating Au/Pd on silicon substrate 170, forming a patterned layer on the substrate, etching away the residual layer, and etching the substrate in 5M HF at 25° C. for 30 minutes. Nanowires 184 have a diameter of about 300 nm and a length of about 300 nm. Protrusions 182 from the patterned layer are adhered to the distal ends of nanowires 184. Portions of metal-containing layer 172 are also visible.

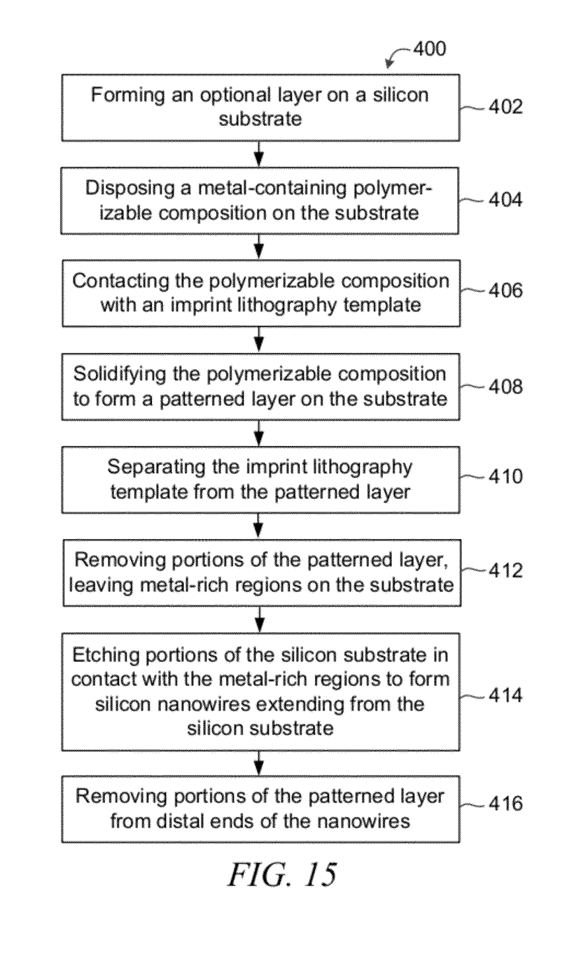

FIG. 15 is a flowchart showing process 400 for forming a silicon nanowire array from a silicon substrate. In 402, an optional layer is formed on a silicon substrate. The optional layer may be, for example, an adhesion layer. In 404, a metal-containing polymerizable material is disposed on the silicon substrate, or on a layer previously formed on the silicon substrate. In 406, the polymerizable material is contacted with a patterned imprint lithography template. In 408, the polymerizable material is solidified to form a metal-containing patterned layer with protrusions and recessions, and in 410 the imprint lithography template is separated from the patterned layer, leaving the metal-containing patterned layer adhered to the silicon substrate. In 412, portions of polymeric material in the patterned layer between the protrusions are removed to expose portions of the silicon substrate, leaving metal-rich regions in contact with the silicon substrate. The portions of the patterned layer between the protrusions can be removed, for example, by a descum process designed to remove a residual layer in an imprint lithography process. In some cases (e.g., when a descum process such as a VUV descum process includes irradiation with UV radiation), metal ions in the portions of the metal-containing patterned layer that are removed undergo light-mediated photoreduction to form metal-rich regions with reduced metal in contact with the silicon substrate.

In 414, an electroless etching process as described herein with respect to FIG. 3 is used to etch portions of the silicon substrate in contact with metal in the metal-rich regions to form nanowires with a cross-sectional shape determined by the pattern in the nanoimprint lithography template. After etching is complete, portions of resist from the patterned layer (e.g., protrusions 50) adhered to distal ends of the nanowires can be removed in 416. Removing this polymeric material may include, for example, dissolving the material with a Piranha solution. In some cases, reduced metal is removed from the silicon substrate using nitric acid or a stripper including potassium iodide, iodine, and water.

In some cases, in addition to removing the residual portions in the descum process as described with respect to 412, the protrusions as well as the residual portions are removed. Removal of the protrusions as well as the residual layer leaves a higher concentration of metal ions from the metal-containing patterned layer in contact with the silicon substrate proximate the locations of the protrusions. These metal-rich regions may facilitate a subsequent electroless etching process.

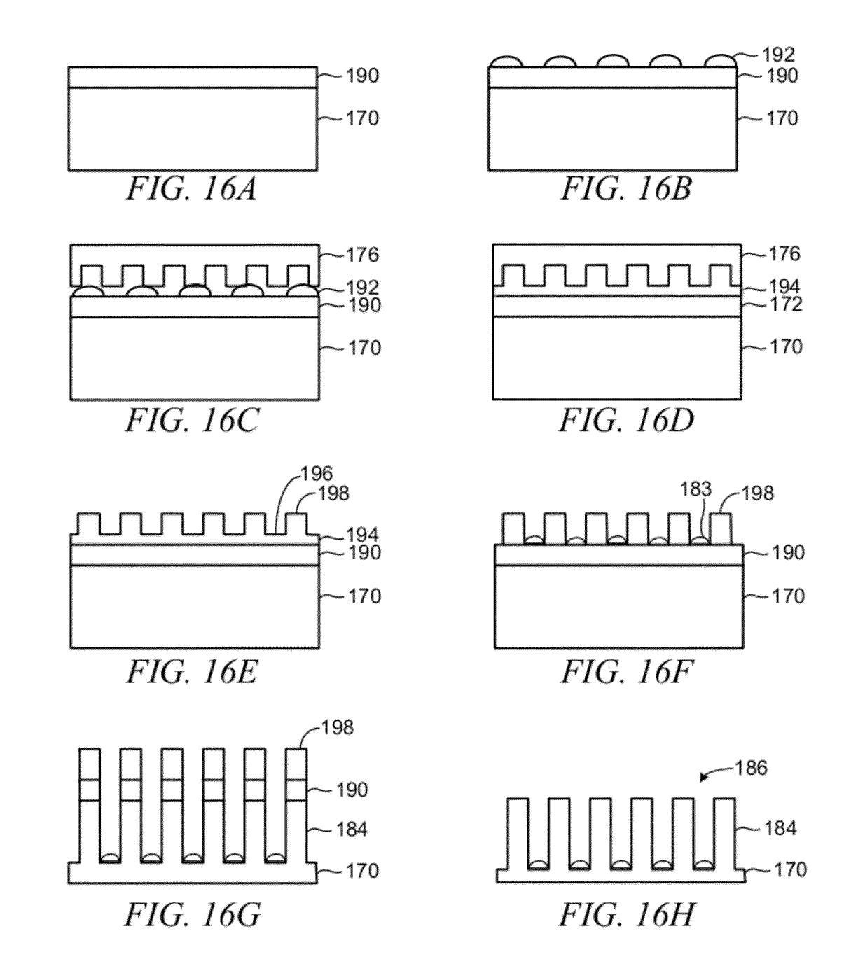

FIGS. 16A-16H illustrate the process described in FIG. 15 in which the polymeric material in the the metal-containing residual layer is removed in a descum process, leaving metal in contact with the silicon substrate. In FIG. 16A, optional layer 190 is shown on silicon substrate 170. In some cases, optional layer 190 is an adhesion layer. Metal-containing polymerizable material 192 is shown on optional layer 190 in FIG. 16B. In FIG. 16C, nanoimprint lithography template 176 is shown in contact with metal-containing polymerizable material 192. Metal-containing polymerizable material 192 is solidified to form metal-containing patterned layer 194, as shown in FIG. 16D. Nanoimprint lithography template 176 is separated from metal-containing patterned layer 194, as shown in FIG. 16E. Metal-containing residual portions 196 are shown between metal-containing protrusions 198. FIG. 16F shows metal-rich regions 183 between protrusions 198 remaining after polymeric material in residual portions 196 has been etched away. Etching of the residual portions may reduce metal ions in the metal-rich regions. FIG. 16G shows silicon nanowires 184 after an electroless etching process (e.g., with an acid such as HF) to etch silicon substrate 170 in contact with reduced metal. Protrusions 198 are shown on the distal ends of the nanowires. In some cases, protrusions 198 and optional layer 190 are removed from the distal end of nanowires 184 in nanowire array 186, as shown in FIG. 16H.

In some embodiments, optional layer 190 is formed from a metal-containing polymerizable composition. For example, optional layer 190 can be a metal-containing adhesion layer. When optional layer 190 is a metal-containing layer, patterned layer 194 can be metal-containing or non-metal-containing.

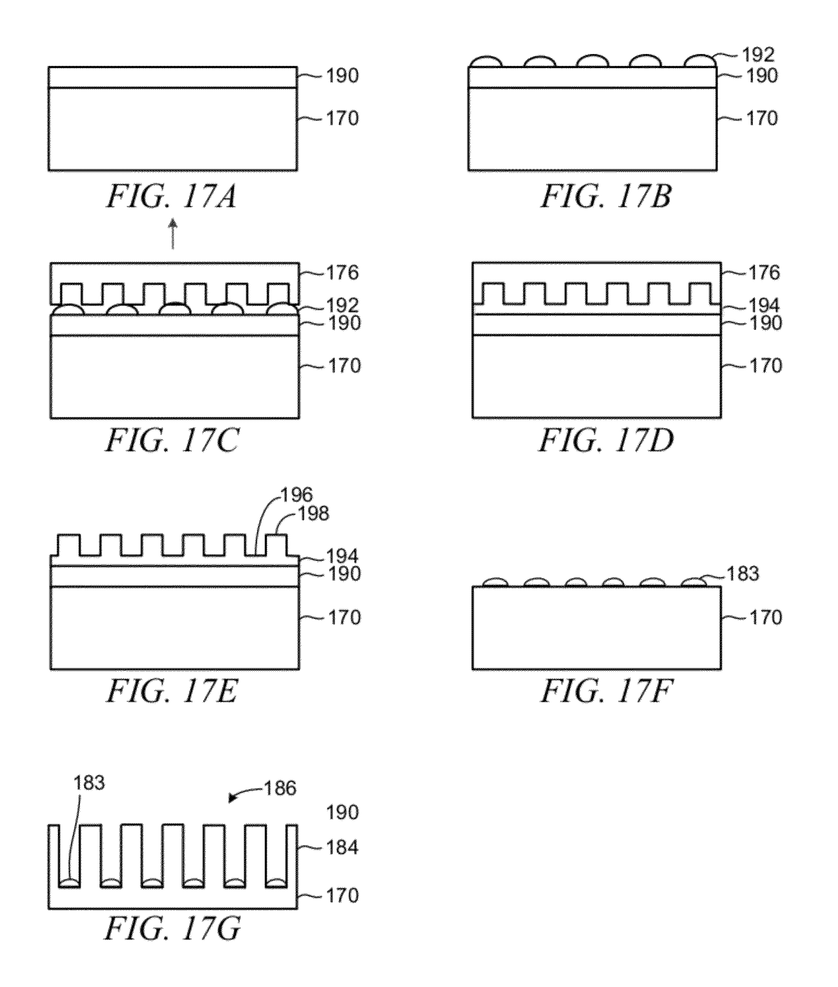

FIGS. 17A-17H illustrate the process described with respect to FIG. 15 in which metal-containing patterned layer 194 is removed in a descum process. In FIG. 17A, optional layer 190 is shown on silicon substrate 170. Metal-containing polymerizable material 192 is shown on optional layer 190 in FIG. 17B. In FIG. 17C, nanoimprint lithography template 176 is shown in contact with metal-containing polymerizable material 192. Metal-containing polymerizable material 192 is solidified to form metal-containing patterned layer 194, as shown in FIG. 17D. Nanoimprint lithography template 176 is separated from metal-containing patterned layer 194, as shown in FIG. 17E. Metal-containing residual portions 196 are shown between metal-containing protrusions 198. FIG. 17F shows metal-rich regions 183 proximate the location of protrusions 198 after metal-containing patterned layer 194 has been etched away. FIG. 17G shows silicon nanowires 184 after an electroless etching process to etch silicon substrate 170 in contact with the reduced metal.

In some embodiments, optional layer 190 is formed from a metal-containing polymerizable composition. For example, optional layer 190 can be a metal-containing adhesion layer. When optional layer 190 is a metal-containing layer, patterned layer 194 can be metal-containing or non-metal-containing (e.g., substantially free of metal).

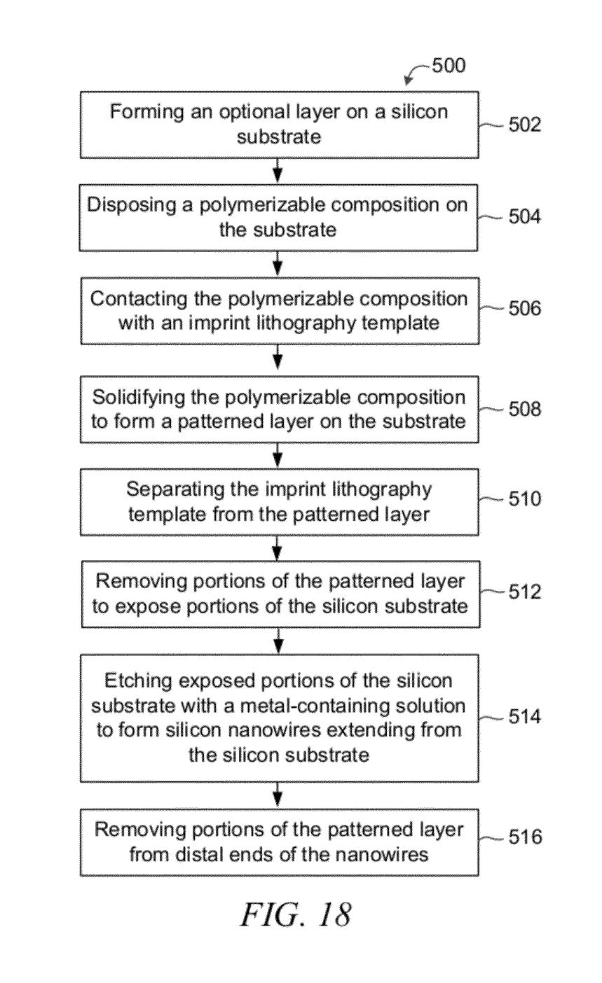

FIG. 18 is a flowchart showing process 500 for forming a silicon nanowire array on a silicon substrate. In 502, an optional layer is formed on a silicon substrate. The optional layer may be, for example, an adhesion layer. In 504, a polymerizable material is disposed on the silicon substrate, or on a layer previously formed on the silicon substrate. In 506, the polymerizable material is contacted with a patterned imprint lithography template. In 508, the polymerizable material is solidified to form a patterned layer with protrusions and recessions, and in 510 the imprint lithography template is separated from the patterned layer, leaving the patterned layer adhered to the silicon substrate.

In 512, portions of the patterned layer between the protrusions are removed to expose portions of the silicon substrate. The portions of the patterned layer between the protrusions can be removed, for example, by a descum process designed to remove a residual layer in an imprint lithography process. In 514, an electroless etching process with an etching solution including metal ions and an acid is used to etch portions of the silicon substrate to form nanowires with a cross-sectional shape determined by recessions in the nanoimprint lithography template.

In process 500, the substrate, the optional layer, and the patterned layer are substantially free of metal. When the etching solution includes noble metal ions and an acid, the noble metal ions are reduced at exposed portions of the silicon substrate, forming metal-rich regions on the substrate, and electroless etching yields silicon nanowires with a cross-sectional shape corresponding to a cross-section shape of the protrusions. Portions of the patterned layer adhered to distal ends of the nanowires can be removed in 516.

A suitable etching solution includes silver ions and hydrofluoric acid (e.g., 5M HF/0.02M AgNO₃). During the etching process, a galvanostatic reaction occurs in which metal ions in the etching solution are reduced, and silicon is oxidized to form silicon dioxide. The hydrofluoric acid reacts with the silicon dioxide to form silicon hexafluoride, etching away silicon in places where the reduced metal is in contact with the silicon.

Etching may occur substantially vertically though the substrate. For example, when an etching solution including silver nitrate and hydrofluoric acid is used, silicon, including crystalline forms of silicon and amorphous and nano/micro crystalline forms of silicon (e.g., silicon films deposited by vacuum techniques including chemical vapor deposition and sputtering) are etched substantially vertically. Vertical etching through the regions of the silicon substrate that surround the protrusions yields pillars (i.e., nanowires) that extend from the silicon substrate. Etching depth (or nanowire length) generally increases with increased etching time.

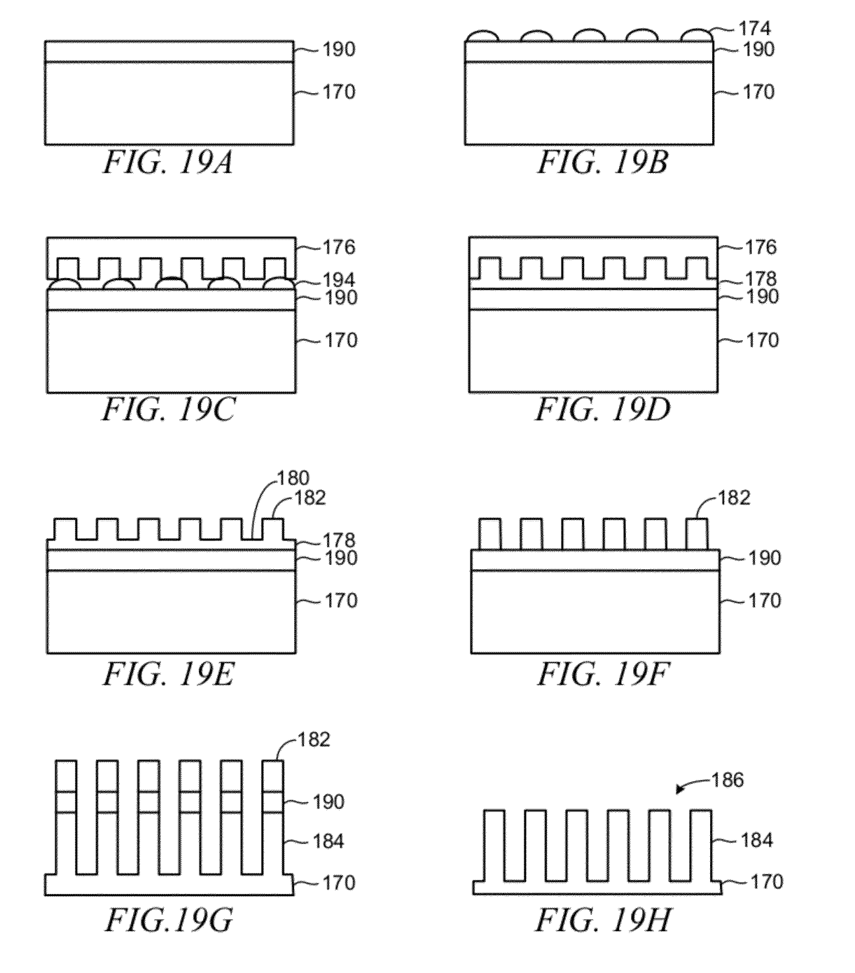

FIGS. 19A-19H illustrate the process described in FIG. 18 in which the residual layer is removed in a descum process. In FIG. 19A, optional layer 190 is shown on silicon substrate 170. Polymerizable material 174 is shown on optional layer 190 in FIG. 19B. In FIG. 19C, nanoimprint lithography template 176 is shown in contact with polymerizable material 174. Polymerizable material 174 is solidified to form patterned layer 178, as shown in FIG. 19D. Nanoimprint lithography template 176 is separated from patterned layer 178, as shown in FIG. 19E. Residual portions 180 are shown between protrusions 182. FIG. 19F shows protrusions 182 remaining after residual portions 180 have been etched away. After silicon substrate 170 is exposed between protrusions 182, a metal-containing electroless etching solution is used to vertically etch the silicon substrate 170 between protrusions 182 to form silicon nanowires. FIG. 19G shows silicon nanowires 184 after an electroless etching process with a metal-containing solution. Protrusions 182 from patterned layer 178 are adhered to the distal ends of nanowires 184. In some cases, optional layer 190 and protrusions 182 are removed from nanowires 184 of nanowire array 186, as shown in FIG. 19H.

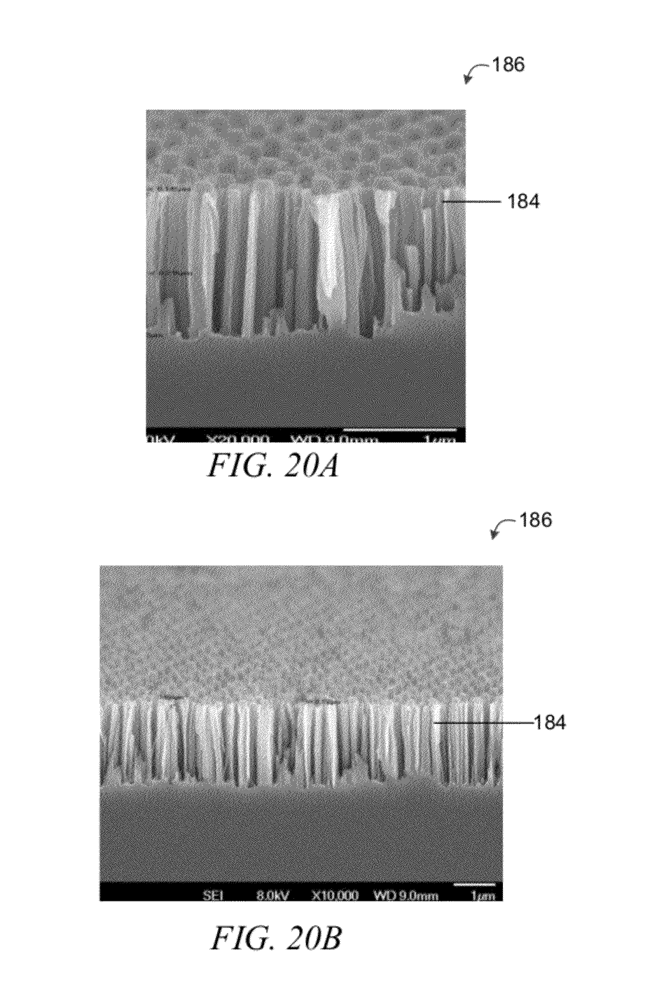

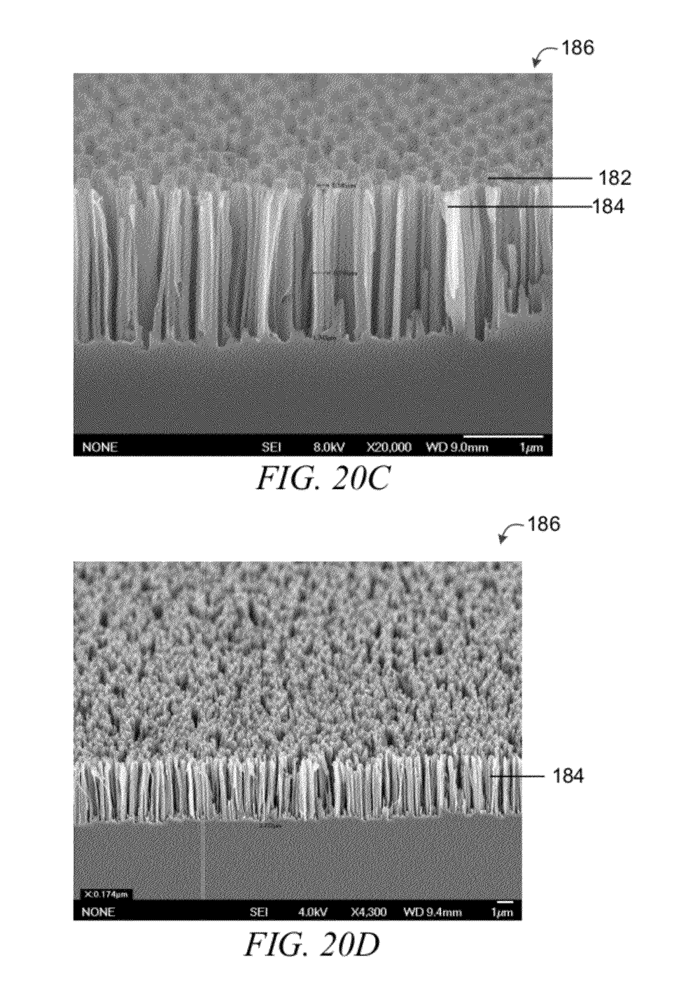

FIGS. 20A-20D show images of nanowire arrays 186 including nanowires 184 formed by coating a <100> silicon wafer with a 1 nm TRANSPIN adhesion layer, and then imprinting with a 530 nm pitch template to produce an array of resist pillars. Following an oxygen plasma descum to remove the residual layer between the resist pillars, leaving metal-rich regions between the pillars, the imprint patterned wafer was subjected to a 15 minute etching process in a 5M HF/0.02M AgNO₃ etching solution. Silicon nanowires 184 have a length of about 1.7 μm and a diameter (or critical dimension (CD)) of about 0.2 μm. As seen in FIG. 20C, protrusions 182 from the patterned layer are adhered to the distal ends of nanowires 184.

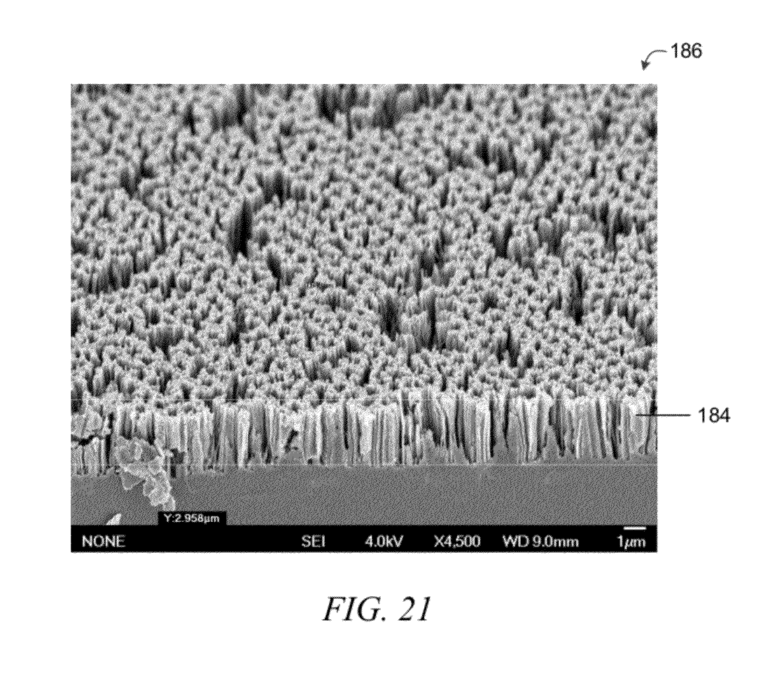

Patterned layers formed in the fabrication of the nanowire arrays shown in FIGS. 14A-14B and 20A-20D were formed with a pillar tone imprint (i.e., hole pattern in the template). However, hole tone imprints (i.e., hole pattern in the resist formed from a pillar tone template) can be used as well. FIG. 21 shows array 186 of silicon nanowires 184 formed from a pillar tone template by the process described with respect to FIG. 18.

The cross-sectional shape of the pillars or nanowires corresponds to the cross-sectional shape of a feature of the patterned nanoimprint lithography template (i.e., a cross-sectional shape of the feature of the patterned nanoimprint lithography template in a direction substantially parallel to the surface of the silicon substrate upon which the patterned layer is formed). The spacing between the silicon nanowires corresponds to the pitch of the features on the patterned nanoimprint lithography template.

In some cases, it is desirable to maximize the ratio of silicon surface area to volume of the nanowire array. A patterned nanoimprint lithography template can be selected to achieve a nanowire cross-sectional shape and packing designed to maximize surface area of the silicon in the nanowire array for a selected nanowire length (etch depth), pitch, etc. A cross-sectional shape of the nanowires can be, for example, circular, elliptical, triangular, rectangular, hexagonal, lobed, or in the shape of square or parallelogram. The nanowires may be in a close packed configuration. A nanowire array of close packed triangular nanowires may provide the maximum surface area for a given array volume. For nanowires with circular cross sections, critical dimensions (or diameters) can range from about 10 nm up to about 500 nm, or between about 50 nm and about 300 nm, with a pitch as low as about 30 nm or between about 100 nm and about 1 μm, and a depth between about 50 nm and about 20 μm. In some embodiments, an aspect ratio of the nanowires (i.e., height:width) is at least about 10:1 or at least about 20:1 and up to about 100:1.

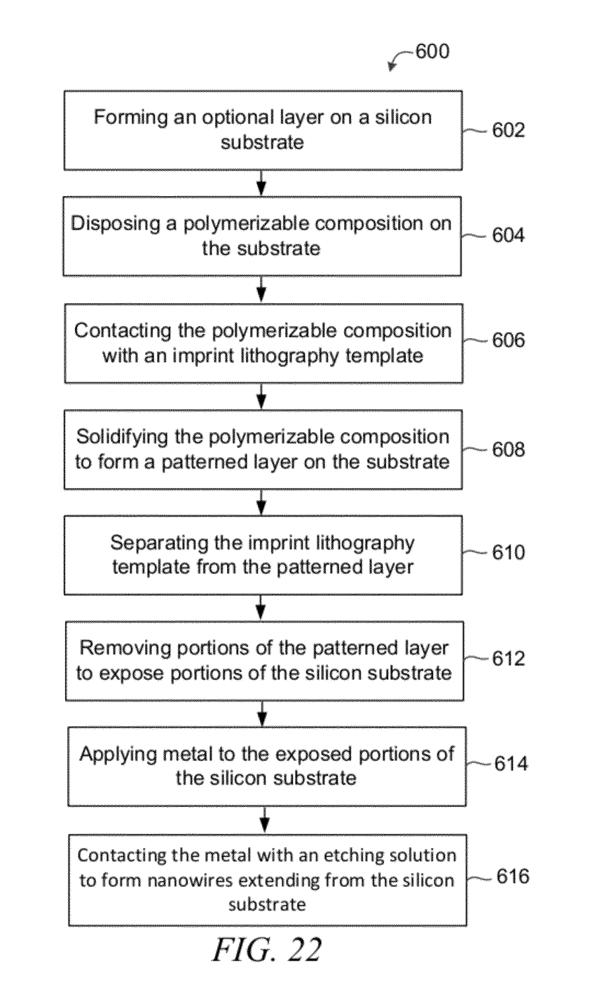

FIG. 22 is a flowchart showing process 600 for forming a silicon nanowire array on a silicon substrate. In 602, an optional layer is formed on a silicon substrate. The optional layer may be, for example, an adhesion layer. In 604, a polymerizable material is disposed on the silicon substrate, or on a layer previously formed on the silicon substrate. In 606, the polymerizable material is contacted with a patterned imprint lithography template. In 608, the polymerizable material is solidified to form a patterned layer with protrusions and recessions, and in 610 the imprint lithography template is separated from the patterned layer, leaving the patterned layer adhered to the silicon substrate.

In 612, portions of the patterned layer are removed to expose portions of the silicon substrate. The portions of the patterned layer can be removed, for example, by a descum process designed to remove a residual layer in an imprint lithography process. In 614, metal (e.g., in a form including metal atoms and/or ions) is applied to the exposed portions of the silicon substrate. The metal may be applied in the form of metal ions or metal in an oxidation state of zero, for example, in a sputtering or evaporation process known in the art. In 616, an electroless etching process with an etching solution including an acid such as HF, as described with respect to FIG. 3, is used to etch portions of the silicon substrate in contact with reduced metal to form nanowires with a cross-sectional shape determined by recessions in the nanoimprint lithography template. In some cases, portions of the patterned layer and the optional layer adhered to distal ends of the nanowires are removed in an additional step.

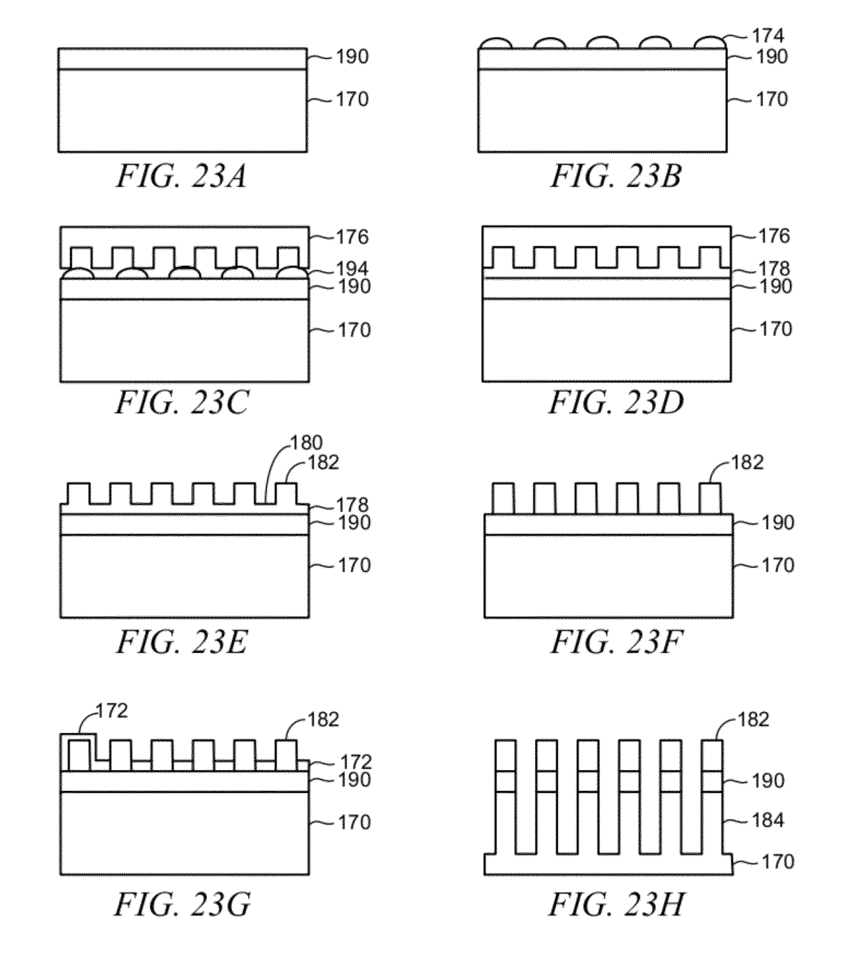

FIGS. 23A-23H illustrate the process described in FIG. 22 in which the residual layer is removed in a descum process. In FIG. 23A, optional layer 190 is shown on silicon substrate 170. Polymerizable material 174 is shown on optional layer 190 in FIG. 23B. In FIG. 23C, nanoimprint lithography template 176 is shown in contact with polymerizable material 174. Polymerizable material 174 is solidified to form patterned layer 178, as shown in FIG. 23D. Nanoimprint lithography template 176 is separated from patterned layer 178, as shown in FIG. 23E. Residual portions 180 are shown between protrusions 182. FIG. 23F shows protrusions 182 remaining after residual portions 180 have been etched away. After silicon substrate 170 is exposed between protrusions 182, metal is applied to exposed portions of the silicon substrate. The metal may be applied in a sputtering or evaporation process. In some cases, as shown in FIG. 23G, the metal is applied to one or more surfaces of protrusions 182 as well as exposed portions of the silicon substrate. If metal ions are present, they may be reduced to form reduced metal in contact with silicon substrate 170. An acid (e.g., 5M HF) can be used to vertically etch the silicon substrate in contact with reduced metal in metal layer 172 to form silicon nanowires. FIG. 23H shows silicon nanowires 184 after an electroless etching process. Protrusions 182 from patterned layer 178 are adhered to the distal ends of nanowires 184. In some cases, optional layer 190 and protrusions 182 are removed from nanowires 184 of nanowire array 186.

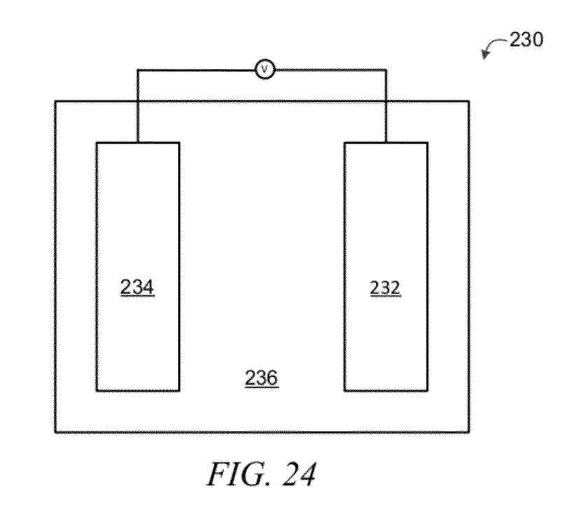

Silicon nanowire arrays formed as described herein with nanoimprint lithography processes can be used as high surface area electrodes. As an example, silicon nanowire arrays can be used as anodes for lithium ion batteries. FIG. 24 shows a schematic view of lithium ion battery 230 with anode 232, cathode 234, and electrolyte 236. Anode 232 is a nanopatterned silicon nanowire array. The large surface to volume ratio of nanopatterned silicon in the nanowire arrays allows rapid charge/discharge cycles and increased charge storage. In addition, feature size and pitch of nanowires in an array can be tuned to improve stress relief during charge/discharge cycles. In some cases, the high aspect ratio of nanowire arrays described herein can be exploited to avoid damage to the anode caused by cracking and pulverization due to the volume change silicon undergoes during a charge/discharge cycle. Thus, the drop in capacity observed for an amorphous silicon film anode may not be observed for nanowire array electrodes.

Nanopatterned silicon nanowire arrays can include other features or can be formed with additional steps to facilitate use as high surface area electrodes. For example, in certain embodiments, conductivity of a nanowire array may be increased by leaving (or adding) metal deposits on a substrate, surrounding the proximal ends of the nanowires at their base.

Nanopatterned silicon nanowire arrays can also be used as elements in thermoelectric coolers and solar cells. Thermoelectric materials convert heat into electricity and vice versa. As the diameter of the nanowire is reduced, the thermal conductivity is reduced while the silicon nanowire still retains good electrical conductivity, providing good thermoelectric efficiency. The ability to produce high aspect ratio patterned silicon arrays on the surface of silicon solar cells allows for enhanced photon absorption and increased cell efficiency. In addition to energy technology, the technique could also be used to fabricate low cost replica templates for nanoimprint processes.

While this document contains many specifics, these should not be construed as limitations on the scope of an invention or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. Variations, modifications and enhancements of the disclosed implementations and other implementations can be made based on what is described and illustrated in this document.

What is claimed is:

1. An method comprising:
disposing a noble metal on a substrate comprising silicon;
selectively etching portions of the substrate with an etching solution, thereby forming a nanowire array comprising a multiplicity of silicon nanowires extending from the substrate, wherein selectively etching portions of the substrate comprises etching silicon in contact with the noble metal.

2. The method of claim 1, wherein disposing the noble metal on the substrate comprises forming a metal-containing layer on the substrate, the metal-containing layer comprising the noble metal, and further comprising:
disposing a polymerizable composition on the metal-containing layer;
contacting the polymerizable composition with a patterned imprint lithography template;
solidifying the polymerizable composition to form a patterned layer on the substrate, the patterned layer comprising protrusions and recessions;
separating the imprint lithography template from the patterned layer; and
removing portions of the patterned layer in the recessions to expose portions of the metal-containing layer,
wherein selectively etching portions of the substrate with the etching solution comprises contacting the exposed portions of the metal-containing layer with the etching solution.

3. The method of claim 2, wherein removing portions of the patterned layer comprises in the recessions to expose portions of the metal-containing layer comprises exposing the portions of the patterned layer in the recessions to vacuum ultraviolet radiation.

4. The method of claim 1, wherein disposing the noble metal on the substrate comprises disposing a polymerizable composition on a silicon substrate, wherein the polymerizable composition comprises the noble metal, and further comprising:
contacting the polymerizable composition with a patterned imprint lithography template;
solidifying the polymerizable composition to form a patterned metal-containing layer on the substrate, the patterned metal-containing layer comprising protrusions and recessions;
separating the imprint lithography template from the patterned metal-containing layer; and
removing portions of the patterned metal-containing layer in the recessions, leaving metal-rich regions between the protrusions,
wherein selectively etching portions of the substrate with the etching solution comprises contacting the metal-rich regions between the protrusions with the etching solution.

5. The method of claim 1, further comprising, before disposing the noble metal on the substrate:
disposing a polymerizable composition on the silicon substrate;
contacting the polymerizable composition with a patterned imprint lithography template;
solidifying the polymerizable composition to form a patterned layer on the substrate, the patterned layer comprising protrusions and recessions;
separating the imprint lithography template from the patterned layer; and
removing portions of the patterned layer to expose portions of the silicon substrate,
wherein the etching solution comprises the noble metal, and disposing the noble metal on the substrate comprises contacting the exposed portions of the substrate with the etching solution.

6. The method of claim 1, further comprising, before disposing the noble metal on the substrate:
disposing a polymerizable composition on the silicon substrate;
contacting the polymerizable composition with a patterned imprint lithography template;
solidifying the polymerizable composition to form a patterned layer on the substrate, the patterned layer comprising protrusions and recessions;
separating the imprint lithography template from the patterned layer; and
removing portions of the patterned layer to expose portions of the silicon substrate,
wherein disposing the noble metal on the substrate comprises applying the noble metal to the exposed portions of the silicon substrate, and selectively etching portions of the substrate with the etching solution comprises contacting the noble metal applied to the exposed portions of the silicon substrate with the etching solution.

7. The method of claim 1, wherein the noble metal comprises noble metal ions.

8. The method of claim 1, wherein the etching solution comprises hydrofluoric acid.

9. The method of claim 1, further comprising forming one or more additional layers on the substrate before disposing the noble metal on the substrate.

10. The method of claim 1, further comprising reducing some of the noble metal in contact with the silicon.

11. The method of claim 1, wherein forming the nanowire array comprises forming nanowires with an aspect ratio of at least 10:1.

12. The method of claim 1, wherein etching the silicon in contact with the noble metal comprises electroless etching.

13. The method of claim 1, further comprising removing non-silicon-containing material from the distal ends of the nanowires.

14. A silicon nanowire array fabricated by the method of claim 1.

15. A silicon nanowire array comprising a multiplicity of silicon nanowires extending from a silicon substrate, wherein a critical dimension of the nanowires is between 10 nm and 500 nm, a pitch of the nanowires is between 100 nm and 1 μm, and a length of the nanowires is between 5 nm and 20 μm.

16. The silicon nanowire array of claim 15, wherein the aspect ratio of the nanowires is at least 10:1.

17. The silicon nanowire array of claim 15, wherein a cross-sectional shape of the nanowires is circular, elliptical, triangular, rectangular, hexagonal, lobed, or in the shape of a square or parallelogram.

18. The silicon nanowire array of claim 15, wherein a length of the nanowires is at least 50 nm.

19. The silicon nanowire array of claim 15, wherein the nanowire array is formed in an electroless etching process.

20. A lithium ion battery comprising an electrode, the electrode comprising the silicon nanowire array of claim 15.
